(19) United States
(12) Patent Application Publication
(10) Pub. No.: US 2019/0236543 A1
(43) Pub. Date: Aug. 1, 2019

(54) BACKUP HOURS OF SERVICE SYSTEM

(71) Applicant: W. Ward Warkentin, Thornhill (CA)

(72) Inventor: W. Ward Warkentin, Thornhill (CA)

(21) Appl. No.: 16/263,672

(22) Filed: Jan. 31, 2019

Related U.S. Application Data
(60) Provisional application No. 62/624,295, filed on Jan. 31, 2018.
(60) Provisional application No. 62/626,724, filed on Feb. 6, 2018.

(51) Int. Cl. G06Q 10/08; G06Q 10/10; G07C 5/08

(52) U.S. Cl. CPC G06Q 10/0838; G07C 5/0841; G06Q 10/1091

(57) ABSTRACT

A system for backing-up tracked working hours of a driver includes a vehicle fleet, a default, system, a backup system, an internal office and operations system, and a harmonizing system. The harmonizing system harmonizes data between the default system and backup system and provides a backup if one such system should fail to provide data for a time. The default system may provide data that is used to generate driver log books. The default system may fail, in which case the data harmonization subsystem may use any available data from the backup system in place of any missing data so as to generate the generate driver log books.

### FIELD

The present invention provides a backup system for tracking a driver's working hours (i.e. duty status). This may be useful when a default electronic logging device (ELD) or ELD system is not functioning. The present invention may also be used to accurately keep track of driver duty status when transferring over to a temporary/backup ELD.

### BACKGROUND

Currently, whenever a driver's ELD is not functioning the driver is required to keep a paper log of the duty status until the ELD's functionality is restored. When this happens, the driver may be forced to recreate previous days' logs, in case a roadside inspector audits the driver for compliance to hours of service (HOS). The present backup system may be used to automatically replenish a driver's previous duty status and ensure continued real-time visibility of hours of service monitoring.

### SUMMARY OF THE INVENTION

According to this disclosure, a fleet owner may maintain two types of ELDs, a default ELD and a backup ELD. The default ELD is typically tethered directly to the engine or can access engine data via a Bluetooth device while the backup ELD may include a smartphone app and may or may not include a sensor that is connected to the engine to access engine data.

A database may be set up to maintain duty status for drivers from both the default and backup ELDs. When a driver goes from the default to the backup device, previous information on the driver's duty status is automatically populated so that previous driver logs may not need to be recreated. When the driver returns to the default ELD (which is in compliance with HOS rules), the backup system may keep track of this information to identify any violations and identify any logs (e.g., which days) that need to be recreated and made available to roadside inspectors as necessary.

### BRIEF DESCRIPTION OF THE DRAWINGS

The invention will now be described by way of example only with reference to the accompanying drawings, in which:

FIG. 1 is an example system architecture that may include a vehicle fleet, a default system, a backup system, and internal office and operations system, and a harmonizing/backup system.

FIG. 2 is an example system architecture that may include a vehicle fleet, a vehicle-aware system, an operator-aware system, and internal office and operations system, and a harmonizing/backup system.

### DETAILED DESCRIPTION

Before the present invention is described in detail, it is to be understood that this invention is not limited to the particular structures, process steps, or materials disclosed herein, but is extended to equivalents thereof as would be recognized by those of ordinary skill in the relevant art in light of this disclosure. It should also be understood that terminology employed herein is used for the purpose of describing particular embodiments only and is not intended to be limiting.

It should be understood that many of the functions described in this specification have been described as embodied in programs stored in memory and executable by processors. Programs may indeed be implemented in software for execution by various types of processors. An identified program of executable code may, for instance, comprise one or more physical or logical blocks of computer instructions, which may, for instance, be organized as an object, procedure, or function. Nevertheless, the executables of an identified program need not be physically located together, but may comprise disparate instructions stored in different locations which, when joined logically together, comprise the program and achieve the stated purpose for the program.

A program may also be implemented as a hardware circuit comprising custom very-large-scale integration (VLSI) circuits or gate arrays, off-the-shelf semiconductors such as logic chips, transistors, or other discrete components. A program may also be implemented in programmable hardware devices such as field programmable gate arrays, programmable array logic, programmable logic devices or the like.

Indeed, a program of executable code may be a single instruction, or many instructions, and may even be distributed over several different code segments, among different programs, and across several memory devices. Similarly, operational data may be identified and illustrated herein within programs, and may be embodied in any suitable form and organized within any suitable type of data structure. The operational data may be collected as a single data set, or may be distributed over different locations including over different storage devices, and may exist, at least partially, merely as electronic signals on a system or network. The programs may be passive or active, including agents operable to perform desired functions.

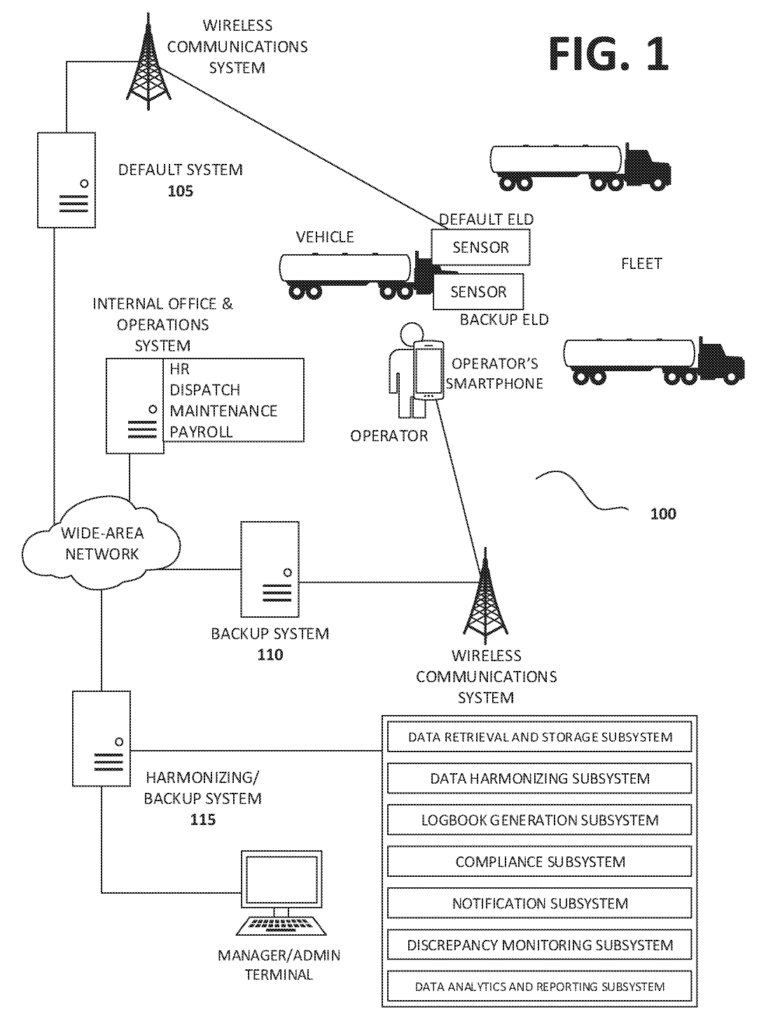

FIG. 1 shows an example system architecture 100 that may include a vehicle fleet, a default system 105, a backup system 110, an internal office and operations system, and a harmonizing/backup system 115. The terms “operator” and “driver” are used interchangeably herein. A vehicle may include a truck, a trailer, a truck with a trailer, a van, and similar.

The default system 105 may include one or more sensors provided to one or more vehicles of the fleet. Such sensors may include sensors to detect driving time, vehicle braking, vehicle crash, vehicle computer fault/information codes, vehicle location (e.g., GPS location), engine speed, vehicle operation time, engine idle time, vehicle lane departures, vehicle mileage, vehicle fuel usage, vehicle speed, vehicle rollover, vehicle tire pressure, and/or similar. A sensor may be provided in an ELD provided to a vehicle.

The backup system 110 may include an operator's mobile device, such as a smartphone, and one or more sensors provided to one or more vehicles of the fleet. Such sensors may include sensors to detect driving time, vehicle braking, vehicle crash, vehicle computer fault/information codes, vehicle location (e.g., GPS location), engine speed, vehicle operation time, engine idle time, vehicle lane departures, vehicle mileage, vehicle fuel usage, vehicle speed, vehicle rollover, vehicle tire pressure, and/or similar. A sensor may be provided in an ELD provided to a vehicle. Such sensors may additionally or alternatively include sensors to detect operator location (e.g., GPS location), operator speed (via GPS), operator inputs (e.g., manual or semi-automated entries into electronic logbooks), and/or similar.

Each of the systems may be implemented by one or more servers. A server may include a processor, memory, a network interface, and may further include a user interface device. Each system, and particularly the harmonizing/backup system 115, may be accessible by a manager/admin terminal, such as a computer or smartphone, which may provide a user interface device for interacting with the system.

Each of the systems may be operated in different domains and/or by different organizations. In one example, the default system 105 is provided by third-party to a company that runs the fleet and its internal office and operations system, the backup system 110 is provided by another third-party, and the harmonizing/backup system 115 by another third-party or by the party that provides the backup system 110.

At each system, a processor, memory, and network interface may be electrically interconnected and can be physically contained within a housing or frame. The server may be computer such as a rack-mount server, blade server, tower server, or another kind of computer, or a process or program running on such a computer. The processor is configured to execute instructions, which may originate from the memory or the network interface. The processor may be known a central processing unit (CPU). The processor may include one or more sub-processors or processing cores. The memory may include a non-transitory computer-readable medium that is configured to store programs and data. The memory may include one or more short-term or long-term storage devices, such as a solid-state memory chip (e.g., DRAM, ROM, non-volatile flash memory), a hard drive, an optical storage disc, and similar. The memory may include fixed components that are not physically removable from the server (e.g., fixed hard drives) as well as removable components (e.g., removable memory cards). The memory allows for random access, in that programs and data may be both read and written. The network interface may be configured to allow the server to communicate with other computers across a wide-area network, such as the internet. The network interface may include one or more of a wired and wireless network adaptor and well as a software or firmware driver for controlling such adaptor. A user interface may include an input device, such as a keyboard, mouse, touch-sensitive element of a touch-screen display, or similar device. The user interface may be remote to the server and provided via the network interface to a manager/admin terminal. One or more programs may be provided to each server to carry out the methods and functionality described herein. Such programs may reference data in the form of databases, files, or other data structures. An example of such a program is a web-based program that generates HTML pages based on data stored in a database.

The harmonizing/backup system 115 may include a data retrieval and storage subsystem, a data harmonization subsystem, a logbook generation subsystem, a compliance subsystem, a notification subsystem, a discrepancy monitoring subsystem, and/or a data analytics and reporting subsystem. These will be discussed in detail below.

Data Retrieval and Storage Subsystem

A data retrieval and storage subsystem may be provided to the harmonizing/backup system 115 to continually retrieve duty status data on at least a daily basis from the default system 105 and backup system 110 as well as internal systems such as the HR system, the dispatching system, and the maintenance system.

The data retrieval and storage subsystem may maintain information on some/all orders dispatched in the system and all drivers that have entered driver duty status information in the default system 105 and/or the backup system 110.

The data retrieval and storage subsystem may include a database that collects and stores data from any of the various systems.

Data Harmonization Subsystem

A data harmonization subsystem may be provided to the harmonizing/backup system 115 to harmonize data between the default system 105 and backup system 110 and to provide backup if one such system should fail to provide data for a time. For example, the default system 105 may provide data that is used to generate driver log books. The default system 105 may fail, in which case the data harmonization subsystem may use any available data from the backup system 110 in place of any missing data so as to generate the generate driver log books.

A data harmonization subsystem may be configured to combine driver data, as drivers switch between the default system 105 and backup system 110, to ensure an accurate assessment of HOS compliance.

In the case of drivers switching from the default system 105 to the backup system 110, data harmonization subsystem may populate data in the backup system 110 to fill duty status events in immediately previous periods.

In the case of switching from backup to the default system 105, data harmonization subsystem may trigger a notification subsystem to send notifications to drivers and fleet managers as compliance issues are identified and may trigger a logbook generation subsystem to generate revised logs for the periods affected by the transition to the default system 105.

Logbook Generation Subsystem

A logbook generation subsystem may be provided to the harmonizing/backup system 115 to generate daily logs covering the periods impacted when switching between default system 105 and backup system 110. Corrected logs may be generated and made accessible to fleet managers and drivers.

Compliance Subsystem

A compliance subsystem may be provided to the harmonizing/backup system 115 to generate compliance analysis results (i.e. identification of violations) from the default system 105 and backup system 110 as part of the driver's overall (i.e. entire day) analysis of HOS compliance. The compliance subsystem may store regulatory and/or best-practice rules to evaluate compliance. In areas where date periods are impacted from switching between systems, a separate and independent analysis of HOS compliance is completed for dates and revised driver logs are generated by the logbook generation subsystem.

The compliance subsystem may insert previous duty status info from the default system 105 for an assessment of compliance

The compliance subsystem may pull information from both the default system 105 and the backup system 110 to assess compliance and trigger notifications as necessary.

Notification Subsystem

A notification subsystem may be provided to the harmonizing/backup system 115 to generate push and summary notifications to fleet managers and drivers while they switch between default system 105 and backup system 110.

Notifications to drivers may be used primarily when drivers switch back to the default system 105 to highlight any non-conformance in the period related to the switch. These notifications list the frequency and types of compliances that have occurred and drivers can be made aware on this information through various means such as driver scorecards.

Notifications to managers may be primarily in the form of summary reports and follow-up action may be taken by managers, as necessary, with reference to such reports.

Discrepancy Monitoring Subsystem

A discrepancy monitoring subsystem may be provided to the harmonizing/backup system 115 to indicate any discrepancies that could lead to inaccurate HOS reporting. A clear example of a discrepancy is a driver is dispatched and there is no corresponding driver log even though the equipment miles showed the delivery occurred.

Output of the discrepancy monitoring subsystem may be provided to the related fleet manager for follow-up action.

Data Analytics and Reporting Subsystem

A data analytics and reporting subsystem may be provided to the harmonizing/backup system 115 to generate various metrics and reports to management to assess a company's performance related to compliance. Sample metrics may include how often compliance issues are occurring or how often are logs not generated.

Various summary reports that relate to issues such compliance notifications, driver utilization, violation summary, missing logs, and discrepancies may be generated.

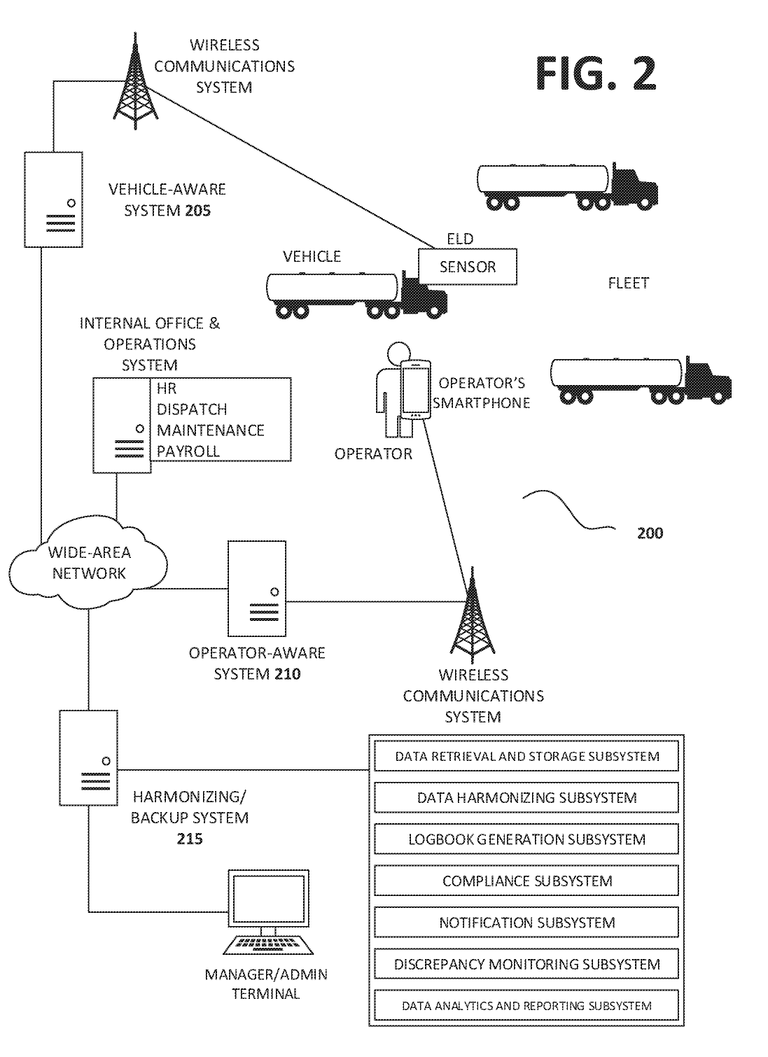

FIG. 2 shows an alternative embodiment, system architecture 200, that may include a vehicle fleet, a vehicle-aware system 205, an operator-aware system 210, an internal office and operations system, and a harmonizing/backup system 215. A vehicle may include a truck, a trailer, a truck with a trailer, a van, and similar.

The person of skill will note that the vehicle-aware system 205 of FIG. 2 replaces the default system 105 of FIG. 1, and the operator-aware system 210 of FIG. 2 replaces the backup system 110 of FIG. 1.

Furthermore, FIG. 2 contemplates an embodiment in which only one ELD is utilized in the vehicle.

While the foregoing provides certain non-limiting example embodiments, it should be understood that combinations, subsets, and variations of the foregoing are contemplated. The monopoly sought is defined by the claims.

What is claimed is:

1. A system for backing-up tracked working hours of a driver, the system comprising,
a vehicle fleet;
a default system;
a backup system;
an internal office and operations system; and
a harmonizing system.

2. The system of claim 1, wherein the default system is a vehicle-aware system.

3. The system of claim 1, wherein the backup system is an operator-aware system.
